(19) United States
(12) Patent Application Publication
(10) Pub. No.: US 2025/0304236 A1
(43) Pub. Date: Oct. 2, 2025

(54) COMPOSITE WINDOW PLUG

(71) Applicant: Wichita State University, Wichita, KS (US)

(72) Inventors: Waruna Seneviratne, Wichita, KS (US); John Tomblin, Wichita, KS (US)

(21) Appl. No.: 19/091,084

(22) Filed: Mar. 26, 2025

Related U.S. Application Data
(60) Provisional application No. 63/570,103, filed on Mar. 26, 2024.

(51) Int. Cl. B64C 1/14; B29C 45/14; B29K 307/04; B29L 31/30; B32B 3/12; B32B 27/08

(52) U.S. Cl. CPC B64C 1/1492; B29C 45/14631; B32B 3/12; B32B 27/08; B29K 2307/04; B29L 2031/3076; B32B 2255/10; B32B 2255/26; B32B 2262/106; B32B 2605/18

(57) ABSTRACT

A composite window plug can be used to plug a window frame in an aircraft, for example, during aircraft conversion and modification services. The composite window plug is formed from a stamped composite laminate and an over-molded rib structure fused to the interior surface of the stamped composite laminate. The over-molded rib structure has multiple ribs extending inwards from a perimeter rib to form a stiffening pattern. The stamped composite and the over-molded rib structure may include a thermoplastic material reinforced with fibers. The composite window plug can be formed in a stamping and over-molding process conducted in a single mold.

### CROSS-REFERENCE TO RELATED APPLICATION

This application claims the benefit of provisional application No. 63/570,103 filed on Mar. 26, 2024, which is incorporated by reference herein in its entirety.

### STATEMENT REGARDING FEDERALLY SPONSORED RESEARCH OR DEVELOPMENT

This invention was made with government support under contract number FA8650-19-C-5212, awarded by the Air Force Research Laboratory (AFRL) Modeling for Affordable Sustainable Composites (MASC). The government of the United States has certain rights in the invention.

### FIELD

This disclosure generally pertains to window plugs, and more specifically, to composite window plugs including a matrix of thermoplastic material.

### BACKGROUND

Window plugs are often used in the conversion of aircraft from passenger transportation to cargo transportation. During conversion, the passenger windows are removed, and the window hole is sealed with a plug. These window plugs must be able to carry the loads imparted by the window frame on the aircraft. In aircraft design, weight is recognized as a principal constraint, therefore the addition of multiple window plugs can introduce a significant amount of weight. Thus, there is increasing interest in a type of window plug that can both carry these window frame loads and weigh less than existing window plugs. To address the global demand for aircraft structures, contractors are aggressively seeking methods for advancing manufacturing technologies through automation, innovative materials, and novel processes that increase manufacturing rates and efficiency.

Injection molding is typically used for manufacturing complex parts at an ultra-high rate and an extremely low cost, especially in automotive and medical applications. Injection molded parts typically require no or minimal machining. During the injection molding process, molten thermoplastic material is injected into a mold cavity to form the part. The part and mold design, thermal management, and injection molding parameters are some of the critical aspects to produce a good quality part. Amorphous or semi-crystalline thermoplastic materials are available for injection molding with or without reinforcement such as glass, short fibers or minerals. Over-molding is a process where a fiber-reinforced thermoplastic component is thermoformed and subsequently injected with a compatible thermoplastic over the surface of the substrate. Like fusion welding, the ability of thermoplastics to remelt, fuse with a compatible adjoining material, and reform by extending the polymer chains across the over-molded interface is the key enabler for the over-molding process.

### SUMMARY

In an aspect, a composite window plug for plugging a window hole in an aircraft during aircraft conversion and modification services is disclosed. The composite window plug comprises a stamped composite laminate having an exterior surface and an interior surface, as well as an over-molded rib structure fused to the interior surface of the composite laminate for stiffening the composite window plug. The over-molded rib structure may contain a continuous perimeter rib and a plurality of ribs within the continuous perimeter rib to stiffen the composite window plug.

In another aspect, a method of manufacturing a composite window plug for plugging a window hole in an aircraft during aircraft conversion and modification services is disclosed. The method comprises heating a composite laminate in an oven to a given processing temperature, placing the heated composite laminate into a mold with a robot. The mold, having at least one over-molding surface and at least one stamping surface, is mounted on an injection molding machine to apply clamping force to stamp and mold the composite window plug. Within the mold, the heated composite laminate is stamped to form the stamped composite laminate. The stamped composite laminate is formed to the contour of the molding surfaces of the mold. An injectable resin is injected into the mold to form an over-molded rib structure that is fused to the stamped composite laminate.

A system for manufacturing composite window plugs for plugging a window hole of an aircraft for aircraft conversion and modification services is also disclosed herein. The system comprises an oven to heat a composite laminate to a given processing temperature. The system also includes the mold comprising a stamping surface and an over-molding surface. The mold is mounted on an injection molding machine. The injection molding machine has an injection system configured to inject at least one type of injectable resin into the mold for forming the over-molded rib structure against the over-molding surface. A robot is configured to move the composite laminate into and out of the oven and into the mold.

In another aspect, a composite window plug for plugging a window hole in an aircraft comprises a stamped composite laminate having an exterior surface and an interior surface and an over-molded rib structure fused to the interior surface of the composite laminate for stiffening the composite window plug.

In another aspect, a method of manufacturing a composite window plug for plugging a window hole in an aircraft comprises heating a composite laminate in an oven to a given processing temperature. The heated composite laminate is placed into a mold with a robot. The mold comprises at least one over-molding surface and at least one stamping surface. Said mold is mounted on an injection molding machine. The composite laminate is stamped with the mold to form a stamped composite laminate. An injectable resin is injected into the mold to form an over-molded rib structure. The over-molded rib structure is fused to the stamped composite laminate to form the composite window plug.

In another aspect, a system to manufacture composite window plugs for plugging a window hole of an aircraft comprises an oven to heat a composite laminate to a given processing temperature. A mold for stamping the composite laminate and forming an over-molded rib structure on the composite laminate comprises a stamping surface and an over-molding surface is mounted on an injection molding machine. An injection system is configured to inject at least one type of injectable resin into the mold for forming the over-molded rib structure against the over-molding surface.

Other aspects will be in part apparent and in part pointed out hereinafter.

### BRIEF DESCRIPTION OF THE DRAWINGS

FIG. 1 is a rear elevation of a prior art machined aluminum window plug;

FIG. 2 is a front elevation of a composite window plug in accordance with the present disclosure.

FIG. 3 is a rear elevation of the composite window plug.

FIG. 3A is a cross section taken in the plane of line B in FIG. 3.

FIG. 4 is an illustration of an exemplary window frame of an aircraft.

FIG. 5 is a side view of a mold for stamping and over-molding the composite window plug.

FIG. 6 is a perspective view of a stamping portion of the mold.

FIG. 7 is a perspective view of an over-molding portion of the mold.

FIG. 8 is a schematic of a method of manufacturing the composite window plug.

FIG. 9 is a flow diagram of a method of manufacturing the composite window plug.

Corresponding parts are given corresponding reference characters throughout the drawings.

### DETAILED DESCRIPTION

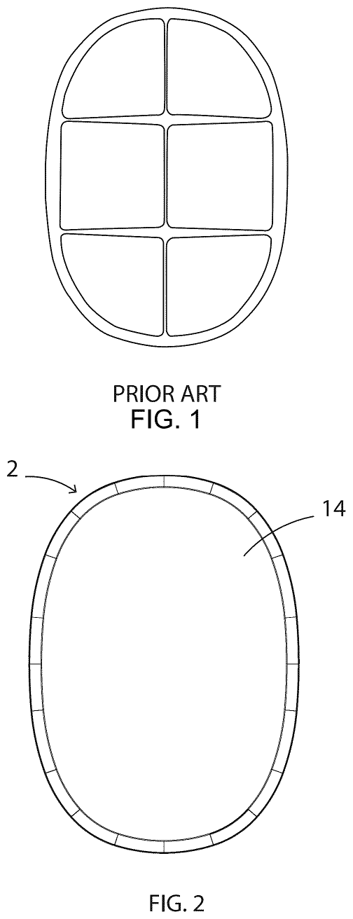

It is desirable to have a window plug for aircraft conversion and/or modification that allows for proper stress management while at the same time reducing weight. Referring to FIG. 1, an example of a conventional window plug is generally illustrated. The conventional window plug comprises a main rib structure and a perimeter rib structure. The conventional window plugs are typically milled aluminum, and accordingly have a thin rib structure to reduce the weight of the window plug. In some cases, these parts are machined from a solid block of material by removing up to eighty percent of the material through cutting, boring, drilling, and grinding to obtain the three-dimensional shape. In theory, this amount of weight saving would be worth the loss of structural integrity that these milled aluminum window plugs undergo. These conventional methods of manufacturing window plugs are time-consuming and inefficient due to the cost of materials used and the large amount of material wasted. Therefore, a new composite window plug is needed which is lighter than a metallic window plug and can be made at an ultra-high rate of production.

This disclosure pertains to a composite window plug for plugging a window hole in an aircraft during aircraft conversion and modification services. In at least one embodiment, the composite window plug is made of thermoplastic composite. Thermoplastic composites are advantageous as they have the ability to sustain multiple process cycles, which is beneficial for recyclability and joining. They are able to be melted and remolded, which allows for the elimination of traditional joining approaches such as mechanical fastening and adhesive bonding. The ability to use non-traditional joining approaches such as fusion welding significantly reduces weight and manufacturing costs. Furthermore, thermoplastics in aircraft structural applications maintain benefits of high-temperature characteristics and impact resistance, as well as chemical, humidity, environmental, and flame resistance. While thermoplastics are advantageous for the primary embodiment, it should be noted that other types of composite materials may be used without departing from the scope of the present disclosure.

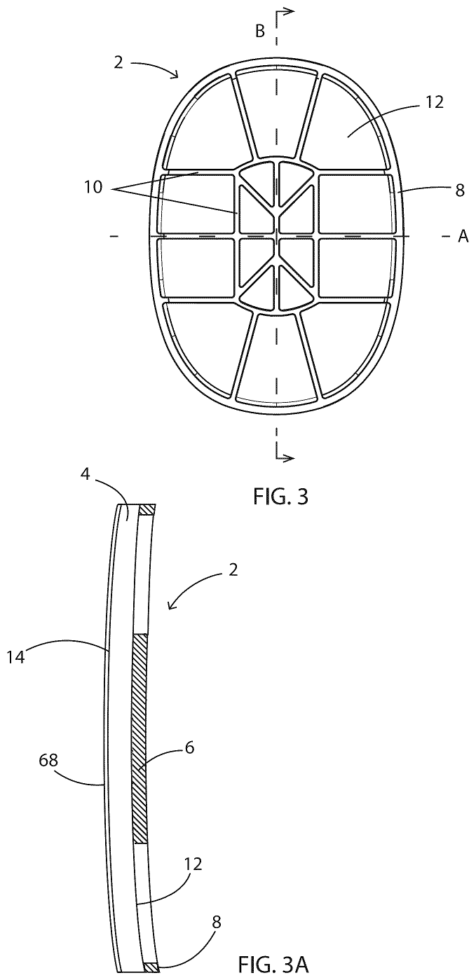

Referring to FIGS. 2-3A, an exemplary embodiment of a composite window plug is generally indicated at reference number 2. The composite window plug generally comprises a stamped composite laminate 4 having an exterior surface 14 and an interior surface 12, and an over-molded rib structure 6 is fused to the interior surface of the composite laminate. The stamped composite laminate 4 comprises a composite laminate 30 which has been cut, heated and stamped to form a desired shape. For example, the composite laminate is stamped to have an elliptical shape corresponding to the shape of a window opening in an aircraft. The composite laminate can also be shaped to have a curvature corresponding to the curvature of an aircraft fuselage. The composite window plug 2 may also be coated with a polyurethane resin 68 on the exterior surface 14 of the composite window plug 2 during the over-molding process, which improves the plug's durability by improving corrosion and scratch resistance.

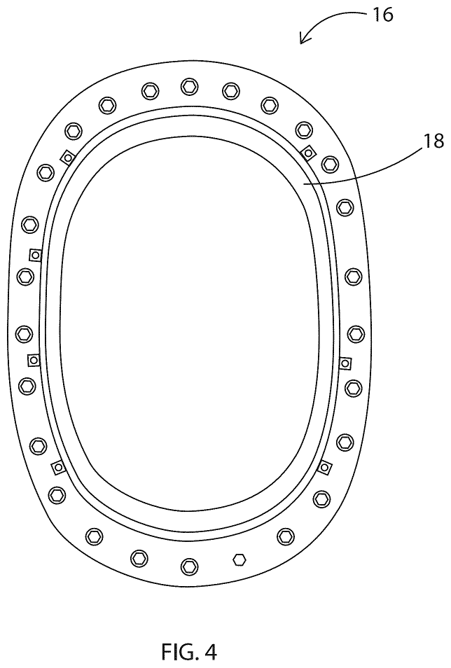

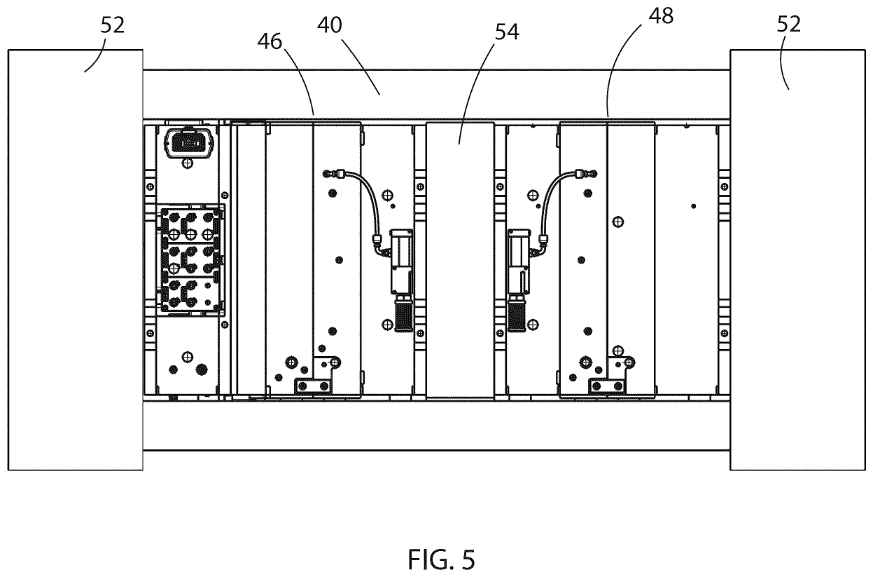

The over-molded rib structure 6 comprises a continuous perimeter rib 8 and a plurality of ribs 10 within the interior of the continuous perimeter rib 8. FIG. 4 shows an example of an aircraft window frame. The exterior surface 14 of the stamped composite laminate 4 is configured to engage with a window frame 16 on an aircraft at a flange area 18 of the window frame 16. A retaining structure and seal may be applied to secure and seal the plug to the window frame 16. The retaining structure may contact the continuous perimeter rib 8.

The sizing, spacing and geometry of the rib structure may vary without departing from the scope of the present disclosure. In the illustrated embodiment, the rib design, sizing, and the skin design were determined by first analyzing a comparable metallic plug under differential pressure loads to obtain a maximum deflection. Using the maximum deflection as the key design driver, a topology optimization analysis cycle was executed for determining the optimum rib design and sizing. The details around the periphery of the composite window plug were constrained as non-design domain to preserve the shape and thickness which is critical to the fit up of the part to the aircraft window frame. The optimization cycle required 64 iterations to converge. Additional FEA was carried out to further optimize the composite window plug design. In this example, the final laminate design is a 16-ply laminate with stacking sequences of [−45/0/0/45/90/−45/0/45]. It is possible that other laminate sequences and stackups could be used, such as 10 plies, 12 plies, or 14 plies, or more than 14 plies. The plurality of ribs 10 are thicker in the center region of the composite window plug to increase the bending rigidity. The ribs contain filets, radii, and have smooth geometric transitions to promote the molding of the ribs while simultaneously stiffening the window plug.

In at least one embodiment, the plurality of ribs 10 extend inward from the perimeter 8 to form a stiffening pattern. In an example, this stiffening pattern is symmetrical along centerlines A and B, as shown in FIG. 3.

In at least one embodiment, the stamped composite skin 4 and the over-molded rib structure 6 are formed in an injection molding machine with over-molding capabilities, wherein injection molding compound pellets are used to form the over-molded rib structure 6 and a continuous fiber reinforced composite laminate 30 is used to form the stamped composite laminate 4. The injection molding machine may be a KraussMaffei GXW 450-2000/1400 dual injection molding machine. This particular machine has data collection functionality that allows the operator to track specific machine parameters during and after the manufacturing. All process and machine parameter data are stored every 20 ms in what is known as the “dataXplorer” and can be accessed locally or exported with a USB flash drive or ethernet connection directly to a server for process diagnosis and traceability. The data acquisition feature was used extensively for data mining and optimization of the composite window plug manufacturing process. The injection over-molding work cell may contain a robot for laminate handling, a heating station positioned above the stationary platen of the machine, a clamping unit for clamping the mold, and an injection unit for injecting the resin. The work cell may additionally contain a laminate supply station and second robot for finished part handling, and a conveyor to move the finished parts. It should be noted that other injection molding machines and work cell arrangements may be used without departing from the scope of the present disclosure.

In an embodiment, Victrex AE350 LM-PAEK with Hexcel AS4 12K carbon fiber is used for the composite laminate 30 and Victrex PEEK 150CA30 injection molding compound pellets are used for the over-molded rib structure 6. PEEK polymer has a high melting temperature of approximately 343° C., which is higher than that of LM-PEAK's melting temperature of approximately 305° C. This example is advantageous because during injection, the PEEK flow front can melt the LM-PAEK surface to promote fusion between the two materials at their interface, while injection and holding pressure facilitate intimate contact between the materials. This promotes molecular reptation dynamics for a stronger bond between the over-molded rib structure 6 and the stamped composite laminate 4.

In an embodiment, the composite laminate may be a thermoplastic material reinforced with continuous carbon fibers. The carbon fibers may be configured in various forms, including woven fabrics, unidirectional fibers, braided, and multiple-ply layups with orthogonal or steered fiber orientations. Alternatively, the thermoplastic material may be reinforced with chopped carbon fiber, either randomly oriented or aligned in a particular orientation. The fibers may be other types of fibers such as glass, aramid, boron, and natural fibers. Regardless of the type of reinforcement chosen, the composite laminate 30 of the current embodiment comprises a plurality of plies of composite material. The composite laminate 30 may be laid up by hand or the fibers may be placed with an automated fiber placement device. In an embodiment, the composite laminate 30 is pre-consolidated by heating the composite laminate and pressing the laminate in a platen press. During stamping, the composite laminate 30 may be cooled in a prescribed rate to achieve the desired crystallinity of the semi-crystalline thermoplastic material.

In an embodiment, the over-molded rib structure 6 is a chopped carbon-fiber reinforced thermoplastic material. In both the over-molded rib structure 6 and the composite laminate 30, the thermoplastic material could include at least one of, but is not limited to, polyaryletherketone, polyetheretherketone, polyetherketoneketone, polyphenylene sulfide, and polyetherimide. The material selected for the over-molded rib structure 6 is an “injectable resin” capable of being injection molded, specifically selected to flow and solidify effectively within the mold cavity during the over-molding process. The over-molded rib structure material is an injectable thermoplastic that can be integrated with the composite laminate, providing structural integrity and desired mechanical properties.

It should be noted that the citation of the above materials should not be seen as limiting, as other composite materials and thermoplastic materials have potential to be used without departing from the scope of the present disclosure. The above materials are instead referenced to provide a non-limiting example of an embodiment that has undergone significant analysis and is shown to be functional, more efficient, and significantly more cost-effective than presently used mechanical and aluminum window plugs.

Also described herein is a method of manufacturing a composite window plug for plugging a window hole in an aircraft during aircraft conversion and modification services. In a primary embodiment, the method comprises heating a composite laminate, placing the heated composite laminate into a mold, stamping the composite laminate with the mold, and forming an over-molded rib structure within the mold, and ejecting the composite window plug from the mold.

FIG. 8 is a simple schematic of the method. During a sheet intake step 802, a robot 34 may retrieve a composite laminate 30 and transfer it to a heating station 32 for a sheet heating step 804. The heating station 32 may be an oven such as an infrared oven or a convection oven, but other high temperature heating devices may be used within the scope of the present disclosure. The composite laminate 30 is heated to a predetermined processing temperature, with an optional step of soaking the laminate to ensure uniform temperature distribution. During a transfer step 806, the robot 34 moves the composite laminate 30 out of the heating station 32 and into the mold 40 after the composite laminate 30 has reached a given processing temperature which may be at the melt temperature of the thermoplastic material or slightly above the melt temperature. Alternatively, the given processing temperature may be at an acceptable softening temperature if the composite laminate doesn't have a defined melt temperature, such as when processing amorphous thermoplastic resins.

In several embodiments, the composite laminate transfer (step 806) is completed by a robot. Any multiaxial robot is acceptable within the scope of the present disclosure, including, but not limited to, a six-axis or seven-axis industrial robot. In current embodiments, the robot has about a 1.5 m distance from the oven to the mold to transport the composite laminate across, which takes approximately one second or less to complete. In one example, when using the Victrex AE250 material, only about a 7° C. heat loss is observed during this transfer, and no material sagging was observed.

In one embodiment, the composite laminate 30 is stamped (step 808) in the mold at the same time that the over-molded rib structure 6 is formed by injection molding (step 810). Alternatively, the composite laminate 30 may be consolidated in a stamping portion 46 of the mold 40 (step 808), then transferred to an over-molding portion 48 within the mold 40 to form the over-molded rib structure 6 (step 810). Either method is acceptable within the scope of the present disclosure. In an embodiment, the mold 40 is designed to accommodate both methods and the injection molding machine has the necessary controls to accommodate both methods.

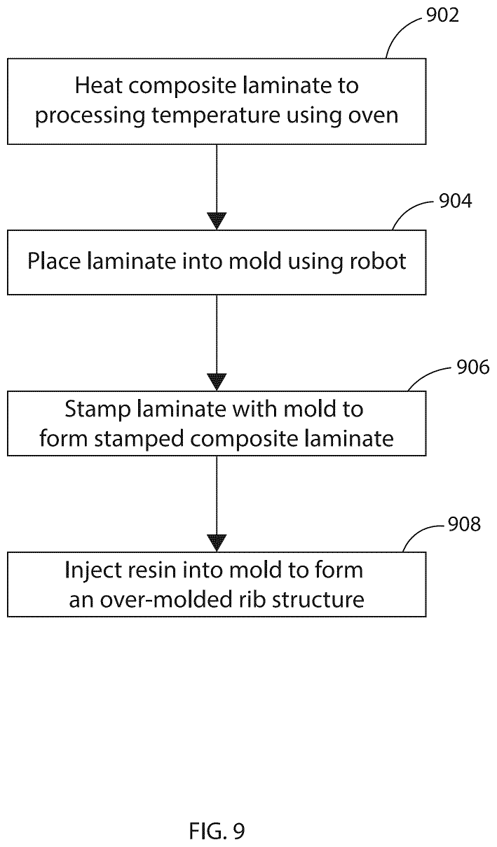

Referring now to FIG. 9, a flow diagram of a method of manufacturing the composite window plug 2 is provided. During a heating step 902, a composite laminate 30 is heated in a heating station 32 to a given processing temperature. The heated composite laminate 30 is placed into a mold 40 with a robot during a placement step 904 after the composite laminate 30 is heated to an acceptable softening temperature for amorphous materials or within 20% of the melting temperature for crystalline or semicrystalline solids during the heating step 902. During a stamping step 906, the composite laminate 30 is stamped with the mold to form a stamped composite laminate 4. During an injecting step 908, an injectable resin into the mold to form an over-molded rib structure 6, the over-molded rib structure 6 being fused to the stamped composite laminate 4 to form the composite window plug 2.

The over-molded rib structure is formed on the interior surface 12 of the stamped composite laminate 4. On the opposite side, the external surface 14 may be coated with a polyurethane (PU) resin 68. The PU resin is injected into the mold with a separate injection system controlled by the injection molding machine. The mold is configured to receive the PU resin through a runner and gate system which is separate from the over-molded rib structure runner system. The PU resin 68 may be injected concurrently with or after the injectable over-molded rib material is injected into the mold 40.

The mold 40 as shown in FIG. 5 encompasses two separate molding portions forming four major mold halves. The over-molding area portion 48 is positioned closest to the injection unit and forms the over-molded rib structure 6 and can optionally form the stamped composite laminate 4 in one step. Alternatively, the stamping portion 46 can form the stamped composite laminate 4 in a step before the stamped composite laminate 4 is transferred to the over-molding portion 48 of the mold 40. This alternative method forms the composite window plug in two separate molding steps. Each mold half may be individually heated through an oil-heating temperature control unit. In some cases, the mold halves are heated to different temperatures. The over-molding portion 48 containing the over-molding surface 64, may be heated to a higher temperature than the opposite half, which is the stamping surface 42c that forms the exterior surface 14 of the stamped composite laminate 4. The mold 40 is mounted onto the platens 52 of the injection molding machine. The injection molding machine moves the platens 52 and provides clamping force when the stamping and molding of the composite window plug is taking place. The over-molding portion 48 of the mold 40 may contain a hot runner system, four injection gates 56 with shut off needles, and the ejector pins for part ejection. One half of the stamping portion 46 and one half of the over-molding portion 48 may be mounted on a swivel plate 54 which can be rotated each cycle. The swivel plate can be used to transfer the stamped composite laminate 4 from the stamping portion 46 to the over-molding portion 48 of the mold 40 if the separate stamping step is employed.

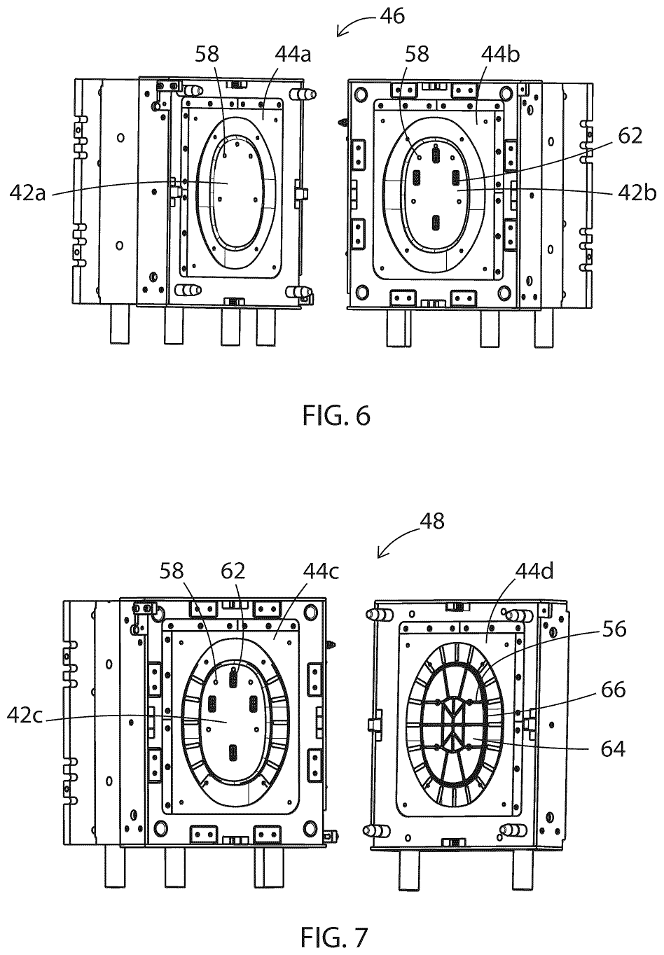

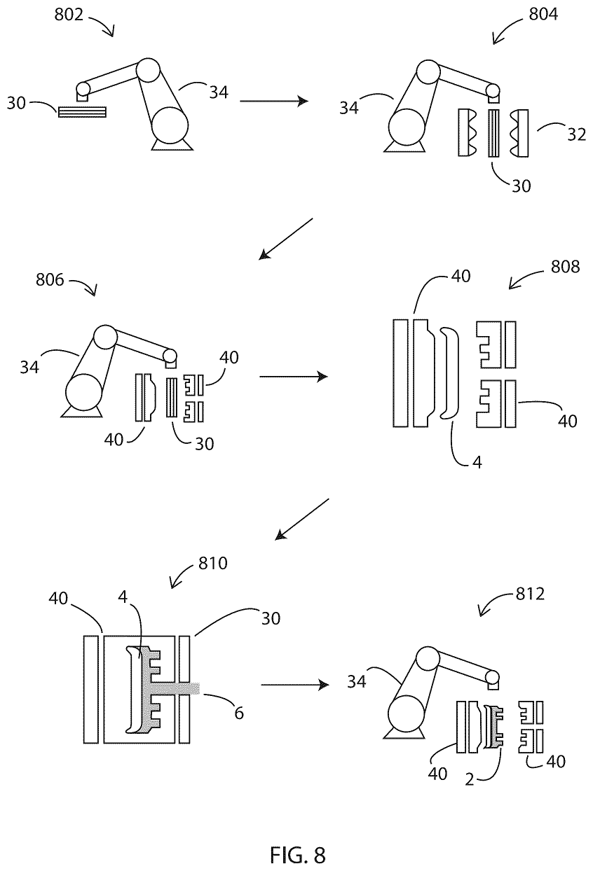

When the robot 34 delivers the laminate to the mold 40, pneumatically actuated laminate pins 58 force the heated composite laminate 30 against the over-molding molding surface 64 to hold the laminate in place when the robot releases the laminate as shown in FIG. 7. Both mold portions are equipped with laminate pins 58 to hold the laminate as the mold is closing as shown in FIGS. 6 and 7. In FIG. 6, the pins may actuate from either half to push the laminate against the stamping surface 42a or 42b. The stamping surfaces 42a, 42b, 42c are the areas of the mold which make contact with the composite laminate 4. A portion of the over-molding surface 64 contacts the composite laminate 4 and also makes up the cavity that will receive the resin that forms the over-molded rib structure 6. Optionally, the mold may contain vacuum ports 62 for holding the stamped composite laminate 4 to the stamping surfaces 42b during the swiveling of the plate to transfer the stamped composite laminate 4 to the over-molding portion 48.

The injection system of the injection molding machine may contain at least one barrel, screw, and hopper for delivering the injection molding pellets to the barrel. The injection system melts the thermoplastic material and injects the material into the clamped mold 40 through a nozzle in fluid communication with a sprue and runner system within the mold 40. The runner system connects with the gates 56 in the over-molding portion 48, the gates 56 allow material to pass into the over-molding surface 64. The over-molding portion 48 mold halves may contain vents 66 for allowing gas to escape during the rapid injection of molten material into the over-molding surface 64 as shown in FIG. 7. In one embodiment, a secondary injection unit may inject a polyurethane resin 68 onto the stamping surface 42c and the exterior surface 14 of the composite window plug 2. The over-molding portion 48 of the mold 40 may contain the ejector pins that push on the formed over-molded rib structure 6 after injection and cooling has taken place.

Because the rib structure is overmolded onto the stamped composite laminate, it is important that the geometry of the rib structure facilitates properly filling the mold cavity. An exemplary embodiment of an overmolding portion of a mold for molding the rib structure is shown in FIG. 7 (discussed in further detail below). In addition to the design of the rib structure, the placement of the gates 56 in the overmolding portion (the gates deliver the injection molding resin into the mold cavity) is an important parameter for ensuring proper filling of the mold cavity. During overmolding, the injected material flow front contacts the interface layer of the stamped composite laminate, the injected resin and the stamped composite fuse, this fusion involves molecular entanglement and is known as reptation. Ideally the stamped composite laminate 4 is at or near melt temperature during the over-molding of the rib structure 6. The composite laminate 4 may be within 20% of the melt temperature during the forming of the over-molded rib structure 6 to promote fusion at the interface of the over-molded rib structure 6 and the composite laminate 4. It is possible the stamped composite laminate 4 could be below the melt temperature and undergoes secondary melting during the filling cycle of the over-molded rib structure 6. The rib design plays a crucial role in governing different phases of the manufacturing cycle: the filling, holding, and cooling phases. The rib design also influences the warpage effects of the final part.

In an example, the injection molding simulation resulted in a total filling time of 2.87 seconds with the hot runner taking the first 1.68 seconds and the ribs taking the remaining 1.19 seconds. The predicted peak injection pressure was 86 KPa and the minimum clamping force required was 141 metric tons. With the current process parameters, 36 composite window plugs can be manufactured in an hour which exemplifies the magnitude of this ultra-high-rate manufacturing process.

In one embodiment, a resin film is placed on at least one surface of the composite laminate 30. The resin may be an unfilled resin compatible with the materials used in the composite laminate 30 and the over-molded rib structure 6, such as LM-PAEK film. During injection of PEEK material under high pressure, the additional resin layer at the interface enhances fusion of the over-molded rib structure to the stamped composite laminate, creating a stronger interface between the two. The additional film at the over-molding interface provides sufficient reptation dynamics (polymer mixing) for forming long polymer chains across the interface. Adding resin to increase the thickness of the laminates potentially increases the consolidation inside the mold cavity and could reduce the wrinkling observed in the stamped composite laminate 4, while also creating a resin-rich surface that has been found to further mitigate wrinkling.

Holding pressure is another molding parameter that may affect wrinkling in the stamped composite laminate 4. During experimentation, when the holding pressure was reduced to an optimal level, wrinkling was prevented.

In the preferred embodiment, the mold 40 has been designed so it is easy to change out the stamping surfaces 42 to accommodate using composite laminates 30 of different thicknesses. For example, a window plug part family may utilize composite laminates with varying layer counts such as 12 ply, 14 ply, and 16 ply configurations. FIGS. 6 & 7 show mold inserts 44a, 44b, 44c, and 44d which can be removed and replaced with different cavity designs. These inserts can be changed to accommodate the varying thicknesses of composite laminates. Likewise, the fuselage curvature may vary in some areas which affects the design of the window plug, so the contour of the inserts may be altered accommodate the variance for a family of window plugs for an aircraft. This allows for a universal mold base to be used, while allowing for changes in geometry of the part, reducing the overall cost of the mold which is a major cost driver in the injection molding process.

After the composite laminate 30 has been stamped and over-molded and the composite material has cooled and solidified, the composite window plug 2 is ejected from the mold 40. The mold 40 may contain ejector pins located in the over-molding portion 48 of the mold 40. In some embodiments, the robot 34 may grip the composite window plug 2 and transfer it to a finishing station or a conveyor. In other embodiments the composite window plug 2 may be ejected directly onto a conveyor.

When introducing elements of the present disclosure or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

What is claimed is:

1. A composite window plug for plugging a window hole in an aircraft, the composite window plug comprising:
a stamped composite laminate having an exterior surface and an interior surface; and
an over-molded rib structure fused to the interior surface of the composite laminate for stiffening the composite window plug.

2. The composite window plug of claim 1, wherein the over-molded rib structure comprises a continuous perimeter rib surrounding a plurality of stiffening ribs.

3. The composite window plug of claim 1, wherein the plurality of ribs extends inward from the perimeter to form a stiffening pattern that is symmetrical along a centerline of the composite window plug.

4. The composite window plug of claim 1, wherein the continuous perimeter rib and the exterior surface of the stamped composite laminate are configured to engage with a window frame on the aircraft.

5. The composite window plug of claim 1, wherein the over-molded rib structure is formed by injection molding.

6. The composite window plug of claim 1, wherein the composite laminate and the over-molded rib structure each include a thermoplastic material.

7. The composite window plug of claim 6, wherein the thermoplastic material in each of the stamped composite laminate and the over-molded rib structure is one of a polyaryletherketone, a polyetheretherketone, a polyetherketoneketone, a polyphenylene sulfide, or a polyetherimide.

8. The composite window plug of claim 6, wherein the over-molded rib structure is reinforced with a chopped carbon fiber.

9. The composite window plug of claim 6, wherein the stamped composite laminate is reinforced with continuous carbon fiber.

10. The composite window plug of claim 1, wherein the composite laminate comprises a plurality of plies of composite material, wherein the mold contains at least one insert with a molding surface, the insert being configured to be removed and replaced with a different insert with a different dimensioned molding surface to form a composite laminate with a different amount of plies.

11. The composite window plug of claim 1, further comprising a polyurethane coating on the exterior surface.

12. The composite window plug of claim 1, wherein the composite laminate is cut to be an elliptical shape.

13. A method of manufacturing a composite window plug for plugging a window hole in an aircraft, the method comprising:
heating a composite laminate in an oven to a given processing temperature;
placing the heated composite laminate into a mold with a robot, the mold comprising at least one over-molding surface and at least one stamping surface, said mold mounted on an injection molding machine;
stamping the composite laminate with the mold to form a stamped composite laminate; and
injecting an injectable resin into the mold to form an over-molded rib structure, the over-molded rib structure being fused to the stamped composite laminate to form the composite window plug.

14. The method of claim 13, wherein the composite laminate is stamped and injected with the injectable resin simultaneously within a single mold portion.

15. The method of claim 13, wherein the stamping of the composite laminate is completed within a stamping portion of the mold prior to the forming of the over-molded rib structure; and subsequently the stamped composite laminate is transferred to an over-molding portion of the mold to form the over-molded rib structure, the stamping and over-molding occurring within different portions of the mold.

16. The method of claim 13, further comprising heating an over-molding surface of the mold to a higher temperature than a stamping surface of the mold.

17. The method of claim 13, further comprising applying a film to the composite laminate on at least one surface of the composite laminate prior to injecting the injectable resin into the mold.

18. The method of claim 13, wherein a polyurethane resin is injected into the mold to form a coating on an exterior surface of the stamped composite laminate.

19. The method of claim 13, wherein the composite laminate is within 20% of melt temperature during the forming of the over-molded rib structure.

20. A system to manufacture composite window plugs for plugging a window hole of an aircraft, the system comprising:
an oven to heat a composite laminate to a given processing temperature;
a mold for stamping the composite laminate and forming an over-molded rib structure on the composite laminate, the mold comprising a stamping surface and an over-molding surface, said mold mounted on an injection molding machine; and
an injection system configured to inject at least one type of injectable resin into the mold for forming the over-molded rib structure against the over-molding surface.
